(19) United States
(12) Patent Application Publication
(10) Pub. No.: US 2002/0164970 A1
(43) Pub. Date: Nov. 7, 2002

(54) Receiver of radio system

(76) Inventor: Kuk-Do Seo, Suwon-city (KR)

Correspondence Address: F. Chau & Associates, LLP, Suite 501, 1900 Hempstead Turnpike, East Meadow, NY, 11554, US

(21) Appl. No.: 10/128,793

(22) Filed: Apr. 23, 2002

(30) Foreign Application Priority Data
Apr. 24, 2001 (KR) 2001-21978

(51) Int. Cl. H04B 1/10

(52) U.S. Cl. 455/296; 455/307

(57) ABSTRACT

A receiver of a radio system is disclosed, which deteriorates a receiver noise figure of an RF or microwave radio system to increase the coverage of radio signals and includes a band pass filter with sharp skirt feature to attenuate signals of unnecessary frequency bands, thereby remarkably improving characteristics of a reception stage of a base station. The receiver includes an active filter constructed in a manner that a first band pass filter for passing only a predetermined frequency band of an input signal and a low noise amplifier for amplifying signals are integrated with each other, the low noise amplifier including a drop-in type isolator for maintaining impedance matching between band pass filters; a second band pass filter for passing only a predetermined frequency band, the second band pass filter being connected to the back end of the active filter; and an amplifier for amplifying signals, the amplifier being connected to the back end of the second band pass filter.

### BACKGROUND OF THE INVENTION

1. Field of the Invention

The present invention generally relates to a receiver of a radio system. More specifically, the invention relates to a receiver of a radio system, which deteriorates a receiver noise figure of an RF or microwave radio system to increase the coverage of radio signals and includes a band pass filter with sharp skirt feature to attenuate signals of unnecessary frequency bands, thereby remarkably improving characteristics of a reception stage of a base station.

2. Description of the Related Art

A conventional RF or microwave radio system is explained with reference to FIG. 1. As shown in FIG. 1, a receiver 10 of the conventional radio system includes a directional coupler 11, a band pass filter 12, a low noise amplifier 13, and a power divider 14. This receiver is constructed in such a manner that the band pass filter 12 is located before the low noise amplifier 13 so as to selectively pass only a frequency band allocated to each radio common carrier.

As the number of radio common carriers increases, radio environments become complicated. Accordingly, a receiver of a radio system such as a base station and repeater increasingly requires to strongly attenuate frequency components other than the frequency allocated thereto. In the case of the conventional radio system receiver constructed in a manner that the band pass filter 12 is placed before the low noise amplifier 13, as shown in FIG. 1, the number of resonators of the band pass filter 12 should be increased or frequency components other than the frequency to be used should be attenuated using a notch. However, although attenuation characteristic can be improved when the number of resonators of the band pass filter 12 is increased, insertion loss corresponding to the increased number of resonators is additionally generated. In addition, in realization of the notch, it is impossible to satisfy sharper attenuation characteristic while maintaining insertion loss since there is a limit in constructing the notch.

Accordingly, when the insertion loss is increased, noise figure of the system increases and coverage of the base station becomes narrow, resulting in reduction in transmission distance and coverage area of radio signals.

### SUMMARY OF THE INVENTION

It is, therefore, an object of the present invention to provide a receiver of a radio system, capable of deteriorating receiver noise figure of the radio system to increase the coverage of radio signals.

Another object of the present invention is to provide a receiver of a radio system, which has a band pass filter with sharp skirt feature to attenuate signals of unnecessary frequency bands, thereby remarkably improving characteristics of a reception stage of a base station.

To accomplish the objects of the present invention, there is provided a receiver of a radio system of a base station, comprising a first band pass filter for passing only a predetermined frequency band of an input signal; a low noise amplifier for amplifying signals, the low noise amplifier being connected to the back end of the first band pass filter; a second band pass filter for passing only a predetermined frequency band, the second band pass filter being connected to the back end of the low noise amplifier; and an amplifier for amplifying signals, the amplifier being connected to the back end of the second band pass filter.

A receiver of a radio system according to another aspect of the invention comprises an active filter constructed in a manner that a first band pass filter for passing only a predetermined frequency band of an input signal and a low noise amplifier for amplifying a signal inputted from the first band pass filter are integrated with each other; a second band pass filter for passing only a predetermined frequency band, the second band pass filter being connected to the back end of the active filter; and an amplifier for amplifying signals, the amplifier being connected to the back end of the second band pass filter.

Here, the receiver may further include an isolator that is connected to the back end of the active filter and maintains impedance matching between the band pass filters.

A receiver of a radio system according to another aspect of the invention comprises an active filter constructed in a manner that a first band pass filter for passing only a predetermined frequency band of an input signal and a low noise amplifier for amplifying signals are integrated with each other, the low noise amplifier including a drop-in type isolator for maintaining impedance matching between band pass filters; a second band pass filter for passing only a predetermined frequency band, the second band pass filter being connected to the back end of the active filter; and an amplifier for amplifying signals, the amplifier being connected to the back end of the second band pass filter.

### BRIEF DESCRIPTION OF THE DRAWINGS

Further objects and advantages of the invention can be more fully understood from the following detailed description taken in conjunction with the accompanying drawings, in which:

FIG. 1 shows the configuration of a receiver of a conventional radio system;

FIG. 2 shows the configuration of a receiver of a radio system according to an embodiment of the invention;

FIG. 3 shows the configuration of a receiver of a radio system according to another embodiment of the invention;

FIGS. 4A, 4B and 4C show simulation results with respect to the conventional radio system receiver of FIG. 1 and the radio system receivers of the invention shown in FIGS. 2 and 3.

FIG. 5 shows the configuration of a receiver of a radio system according to an embodiment of the invention;

FIG. 6 shows a simulation result with respect to the radio system receiver shown in FIG. 5;

FIG. 7 shows the configuration of an active filter used for the radio system receiver according to another embodiment of the invention;

FIG. 8 shows the output waveform of the active filter of FIG. 7;

FIG. 9 shows the configuration of a band pass filter used for the active filter of FIG. 7;

FIG. 10 shows the output waveform of the band pass filter of FIG. 9;

FIG. 11 shows the configuration of a radio system receiver constructed using the active filter;

FIG. 12 shows the output waveform of a band pass filter;

FIG. 13 shows a simulation result with respect to the receiver of FIG. 11; and

FIGS. 14 and 15 show the final output waveforms of the radio system receiver of FIG. 11.

### DETAILED DESCRIPTION OF THE PREFERRED EMBODIMENT

The present invention will now be described in connection with preferred embodiments with reference to the accompanying drawings.

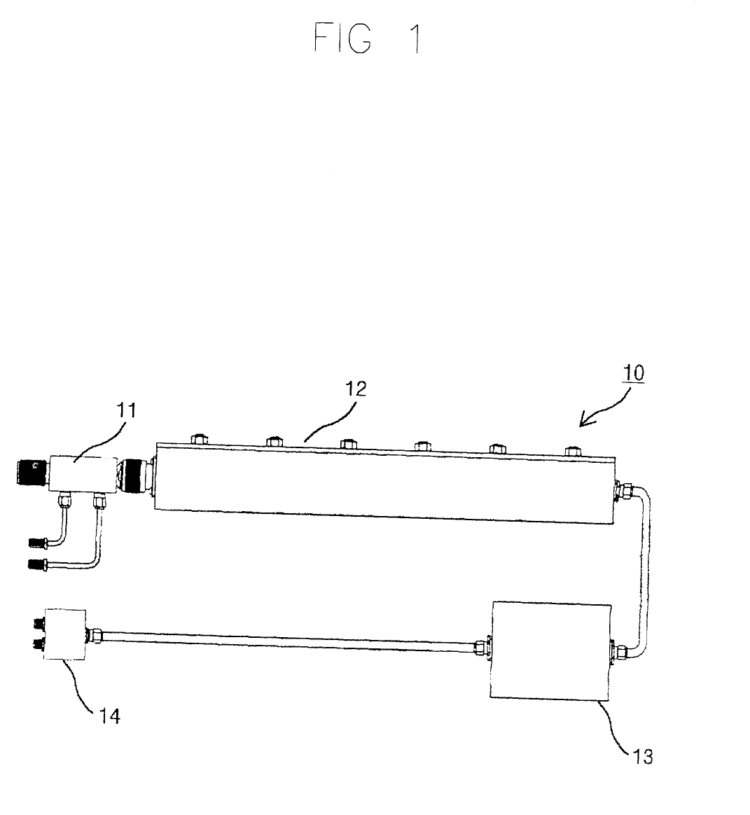

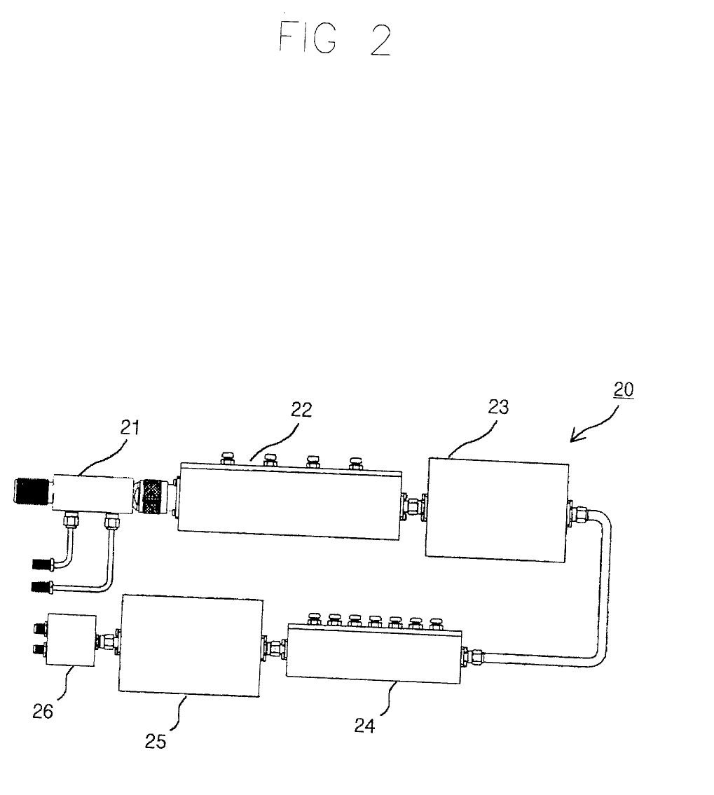

FIG. 2 shows the configuration of a receiver 20 of a radio system according to an embodiment of the present invention. Referring to FIG. 2, the receiver 20 includes a directional coupler 21, a first band pass filter 22, connected to the back end of the directional coupler 21, for passing only a predetermined frequency band, a low noise amplifier 23, connected to the back end of the first band pass filter 22, for amplifying signals, a second band pass filter 24, connected to the back end of the low noise amplifier 23, for passing only a predetermined frequency band, an amplifier 25 that is connected to the back end of the second band pass filter 24 and amplifies signals, and a power divider 26 that is connected to the back of the amplifier 25 and divides power. In other words, the receiver 20 of the invention is constructed in such a manner that the first band pass filter 22, low noise amplifier 23, the second band pass filter 24, and amplifier 25 are sequentially arranged. The radio system receiver 20 constructed as above employs the band pass filters 22 and 24 that satisfy the attenuation characteristic of the band pass filter used for the receiver of the convention radio system shown in FIG. 1 because its output attenuation characteristic is identical to that of the band pass filter.

Though the radio system receiver 20 includes the directional coupler 21 in this embodiment, the directional coupler 21 may be omitted when the system does not require an additional detection function because the directional coupler 21 is used for sampling input/output signals to confirm if signals in a passband operate normally. This fact is consistent in the following embodiments. Further, although the receiver 20 includes the power divider 26 in this embodiment, the power divider can be omitted if required because it only divides power. A 2-way divider is shown in FIG. 2 as the power divider but the power divider is not limited thereto and a 3-way divider or more can be also used as the power divider. This point is also consistent in the following embodiments.

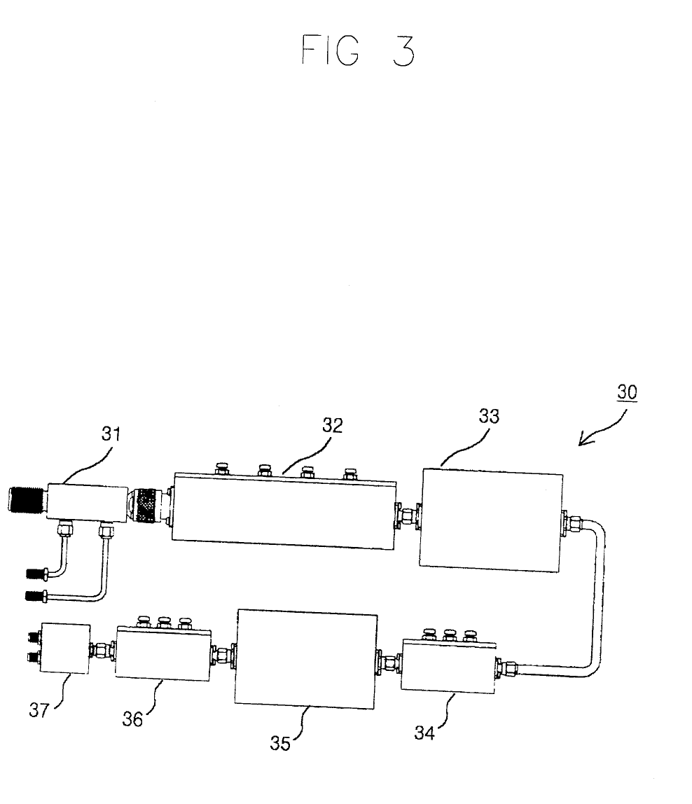

FIG. 3 shows the configuration of a receiver of a radio system according to another embodiment of the invention. Referring to FIG. 3, the receiver 30 includes a directional coupler 31, a first band pass filter 32 that is connected to the back end of the directional coupler 31 and passes only a predetermined frequency band, a low noise amplifier 33 that is connected to the back end of the first band pass filter 32 and amplifies signals, a second band pass filter 34, connected to the back end of the low noise amplifier 33, for passing only a predetermined frequency band, an amplifier 35, connected to the back end of the second band pass filter 34, for amplifying signals, a third band pass filter 36 connected to the back end of the amplifier 35 to pass only a predetermined frequency band, and a power divider 37 that is connected to the back of the third band pass filter 36 to divide power. That is, the receiver 30 is constructed in a manner that the third band pass filter 36 is inserted between the amplifier 25 and power divider 26 shown in FIG. 2.

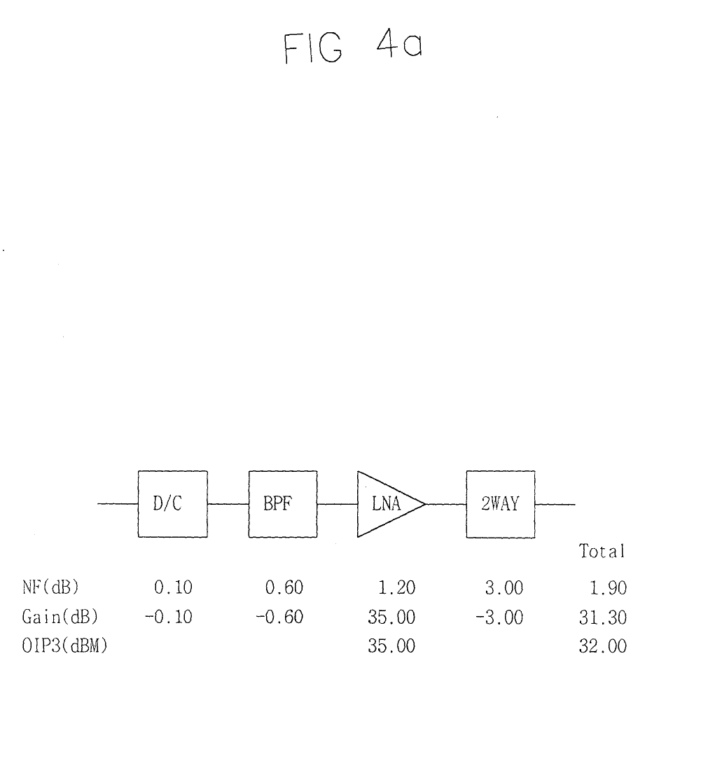

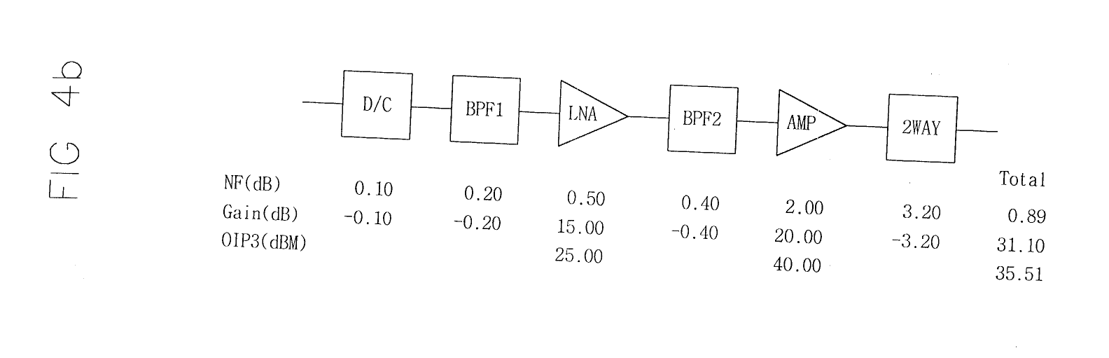

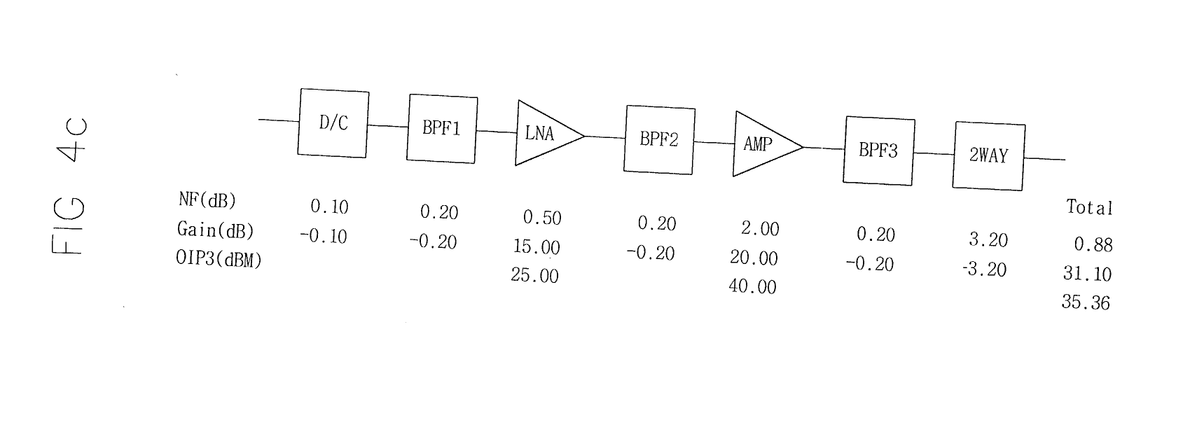

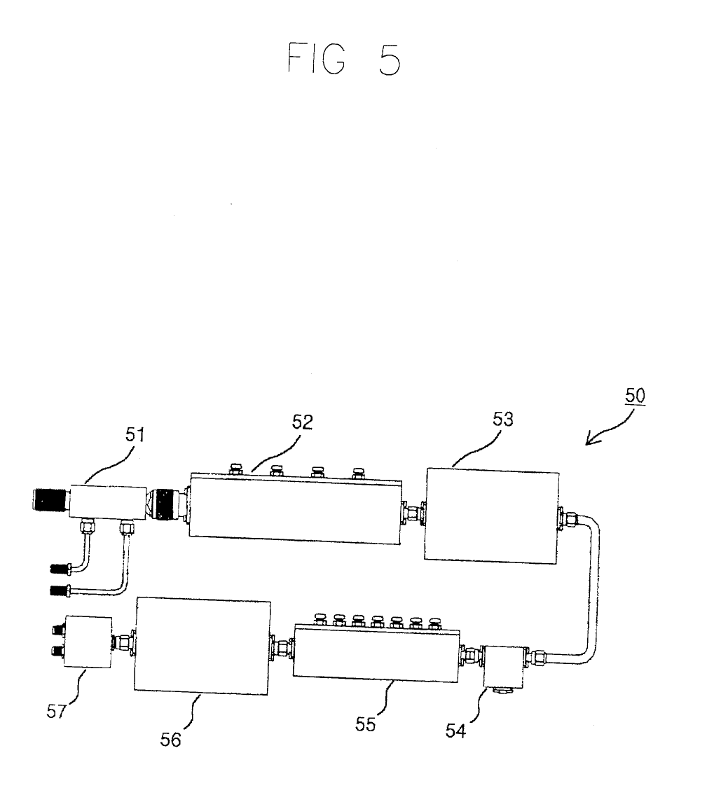

FIGS. 4A, 4B and 4C show simulation results with respect the receivers of the invention shown in FIGS. 2 and 3.

FIG. 4A shows a simulation result with respect to the conventional radio system receiver. The system's attenuation characteristic was satisfied by using a band pass filter having six-stage metal resonators placed before a low noise amplifier. The low noise amplifier has gain of 35 dB and noise figure of 1.2 dB. In this case, gain of 31.3 dB and noise figure of 1.90 dB were outputted.

FIG. 4B shows a simulation result with respect to the radio system receiver according to the embodiment of the invention shown in FIG. 2. For the simulation, the first band pass filter 22 having loss of 0.2 dB was located before the low noise amplifier 23 and the second band pass filter 24 having remaining loss was placed between the low noise amplifier 23 and the amplifier 25 to improve the noise figure of the entire system. In this case, gain is 31.1 dB and noise figure is 0.89 dB.

FIG. 4C shows a simulation result with respect to the radio system receiver according to the invention shown in FIG. 3. For the simulation, band pass filters each of which has loss of 0.2 dB were located before and after the amplifier 35. In this case, gain is 31.1 dB and noise figure is 0.88 dB.

FIG. 5 illustrates the configuration of a radio system receiver according to another embodiment of the invention. Referring to FIG. 5, the receiver 50 includes a directional coupler 51, a first band pass filter 52 that is connected to the back end of the directional coupler 51 and passes only a predetermined frequency band, a low noise amplifier 53 that is connected to the back end of the first band pass filter 52 and amplifies signals, an isolator 54 that is connected to the back end of the low noise amplifier 53 and maintains impedance matching between band pass filters, a second band pass filter 55 that is connected to the back end of the isolator 54 and passes only a predetermined frequency band, an amplifier 56 connected to the back end of the second band pass filter 55 to amplify signals, and a power divider 57 connected to the back end of the amplifier 56 to divide power.

That is, the receiver 50 is constructed in a manner that the isolator for maintaining impedance matching between the band pass filters is inserted between the low noise amplifier 53 and the band pass filter 55. The isolator 54, a microwave passive element having directivity, passes signals with a small loss in one direction and blocks signals in opposite direction. Generally, a separate tuning process for impedance matching is required for the connection between microwave devices. Accordingly, the isolator is employed to solve this problem in this embodiment. In the configuration of FIG. 5, the stages of the band pass filter are divided so that drawbacks in the attenuation characteristic and loss and difficulties in impedance matching can be solved.

In the embodiment shown in FIG. 5, the isolator 54 can be integrated with the second band pass filter. In this case, the second band pass filter 55 and isolator 54 connected to the front end of the band pass filter 55 are integrated with each other. Here, a drop-in type isolator 54 can be used. Since the isolator integrated with the band pass filter occupies a small space inside the system, compared to a coaxial connector type isolator, the system size can be reduced.

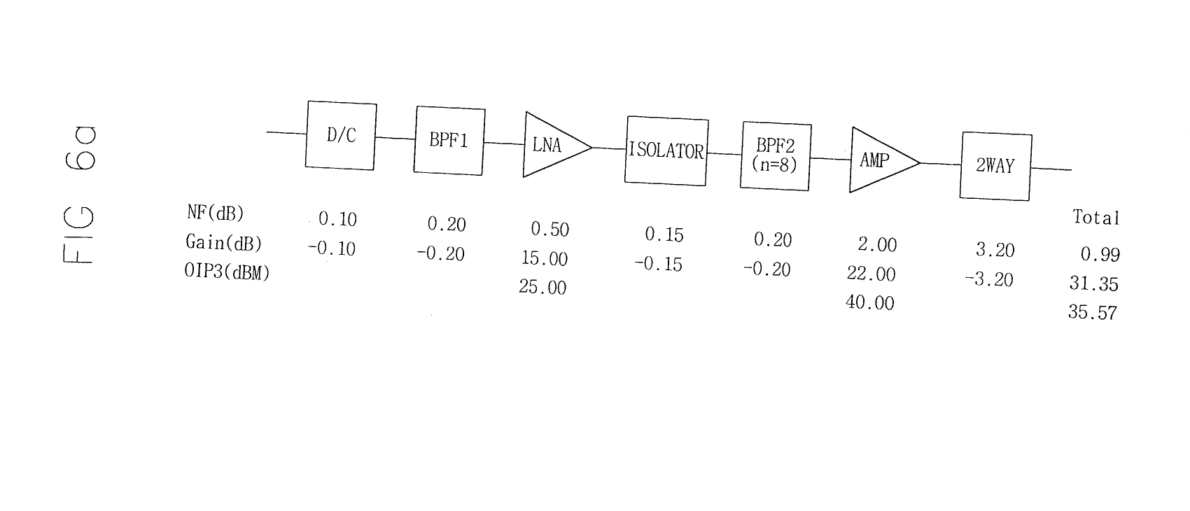

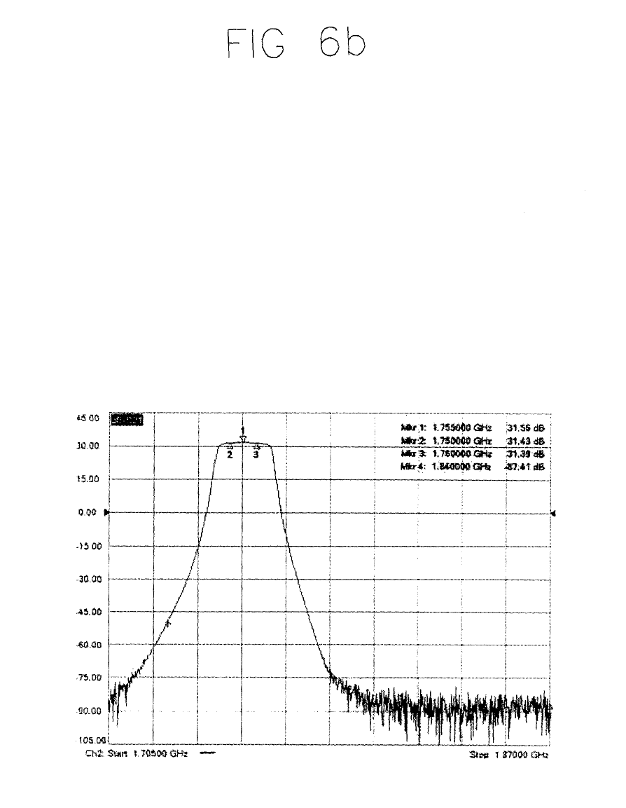

FIGS. 6A and 6B show simulation results with respect to the receiver 50 shown in FIG. 5. The band pass filter has eight stages (insertion loss of 2.0 dB) of resonators for improved attenuation characteristic. As shown in FIGS. 6A and 6B, gain is 31.35 dB and noise figure is 0.99 dB.

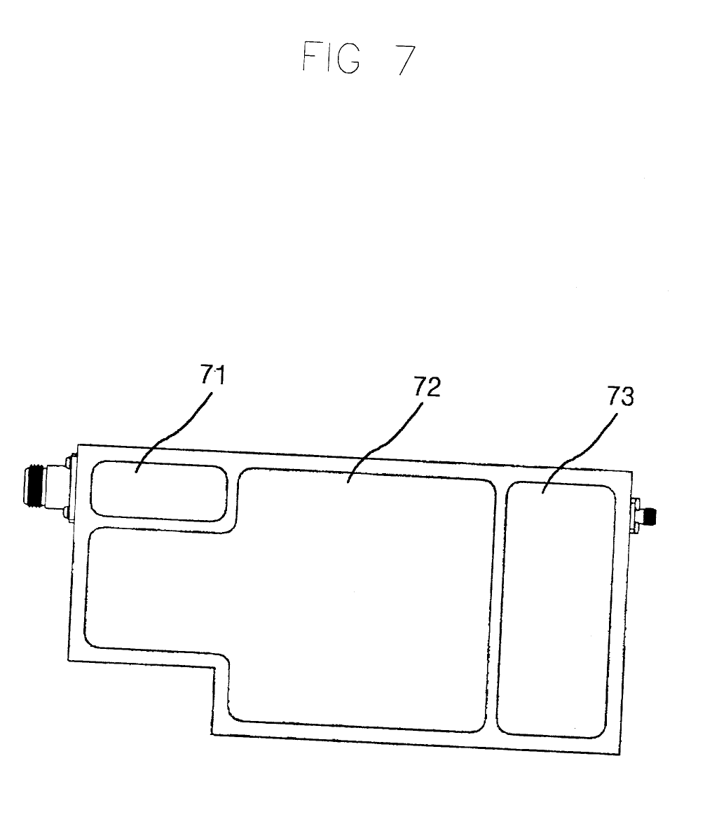

FIG. 7 shows the configuration of an active filter used for the radio system receiver according to another embodiment of the invention. The active filter is constructed in a manner that a directional coupler 71, a band pass filter 72 and a low noise amplifier 73 are integrated into one device. The active filter reduces insertion loss between connectors to decrease noise figure, and occupies smaller space to make the receiver small-sized. The stable operation of the low noise amplifier 73 and minimization of noise figure are important for construction of the active filter. For the stable operation of the low noise amplifier 73, the magnitude of power applied to the low noise amplifier 73 set inside the active filter requires to be less than the standard of the low noise amplifier. In other words, the low noise amplifier can operate stably, not being saturated, only when power applied thereto is less than 1 dB compression point thereof.

In general, power of the transmission stage of the base station rather than its reception stage affects the operation of the low noise amplifier. In order to block the power of the transmission stage, the band pass filter of the active filter should be appropriately designed on the basis of the following points.

First of all, the power of the transmission stage must be attenuated to a range where the low noise amplifier can operate for the stable operation of the low noise amplifier. When the output power of the transmitting stage is 100 W grade and 1 dB compression point of the low noise amplifier is 0 dBm (based on input), attenuation of the band pass filter for the operation of the low noise amplifier is 50 dBm(=10 log(100 W×103))+0 dBm. That is, attenuation of above 50 dBc in the frequency range of the transmission stage is required.

Furthermore, in order to minimize the noise figure of the active filter, loss of the band pass filter placed before the low noise amplifier of the active filter should be minimized. For this, it is required that the number of stages of the resonator should be minimized and passband should be maximized within a range satisfying the attenuation characteristic of the transmission stage.

When the output power of the transmission stage is 1000 W grade and input 1 dB suppression point of the low noise amplifier is 0 dBm, attenuation of the band pass filter is 60 dBm(=10 log(1000 W×103))+0 dBm. That is, attenuation of above 60 dBc is needed.

In addition, to design the band pass filter such that its insertion loss is within 0.3 dB, it is required that the number of resonators of the band pass filter be four, passband width be 25 MHz or higher, and a notch is constructed to block the power of the transmission stage as much as possible.

Moreover, the most important point in the design of the low noise amplifier of the active filter is minimization of noise figure. Generally, the conventional radio system receiver uses a low noise amplifier with high gain. Accordingly, multiple stages of transistors are constructed inside the low noise amplifier to result in an increase in the noise figure.

The present invention designs the low noise amplifier of the active filter in a manner that it has a satisfactory noise figure and relatively low gain. The standard of the low noise amplifier used for the active filter of the invention is as follows.

1. Gain: 14.0±1 dB

2. Return loss: more than 20 dB

3. Gain flatness: less than ±0.1 dB

4. Noise figure: less than 0.6 dB

5. 1 dB compression point: more than 14 dBm (based on output) (more than 0 dB based on input)

6. OIP3: more than 25 dBm

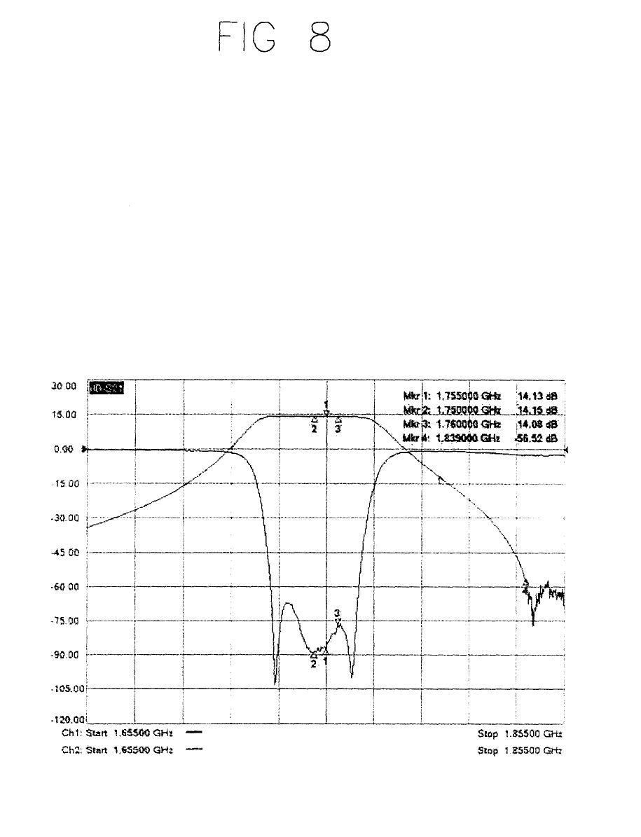

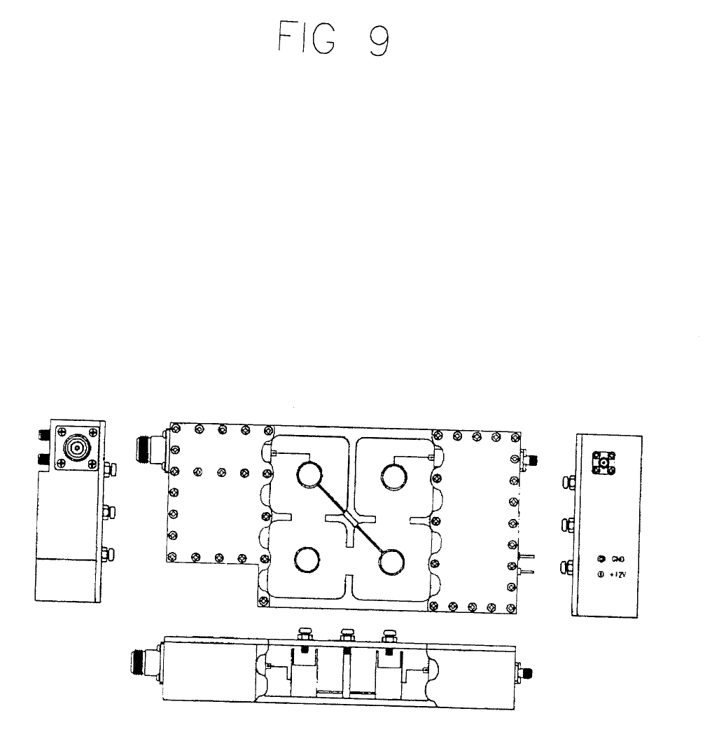

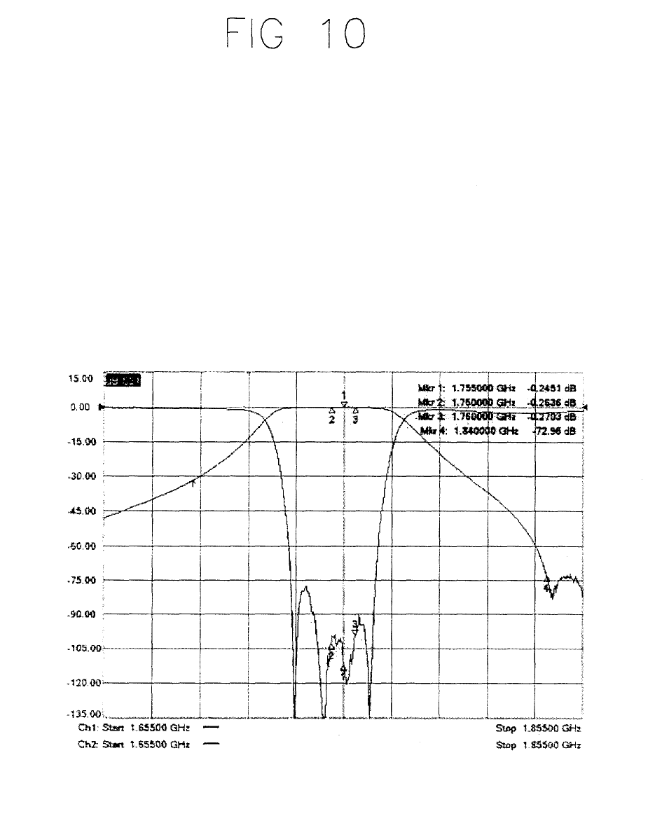

FIG. 8 illustrates the output waveform of the active filter constructed as above, and FIG. 9 shows the configuration of the band pass filter used for the active filter having the aforementioned design standard. FIG. 10 illustrates the output waveform of the band pass filter.

In the active filter described in FIGS. 7 to 10, the directional coupler can be omitted. Specifically, as shown in FIG. 2, the directional coupler samples input/output signals to confirm if signals in a passband operate normally or not. Thus, only the directional coupler is separated from the system and replaced with a connector. Otherwise, the directional coupler may be not employed for the active filter when an additional detection function is not required. In this case, the active filter can be constructed of only the band pass filter and the low noise amplifier.

Furthermore, in the active filter described with reference to FIGS. 7 to 10, an isolator can be integrated with the active filter. The isolator that passes a signal with small loss in one direction and blocks a signal in opposite direction, as described above, is integrated with the back end of the low noise amplifier of the active filter. By doing so, the isolator allows a signal outputted from the active filter to travel to the band pass filter connected to the back end of the isolator and blocks reflected wave components generated when the signal is combined with the band pass filter, thereby obtaining stable output characteristic.

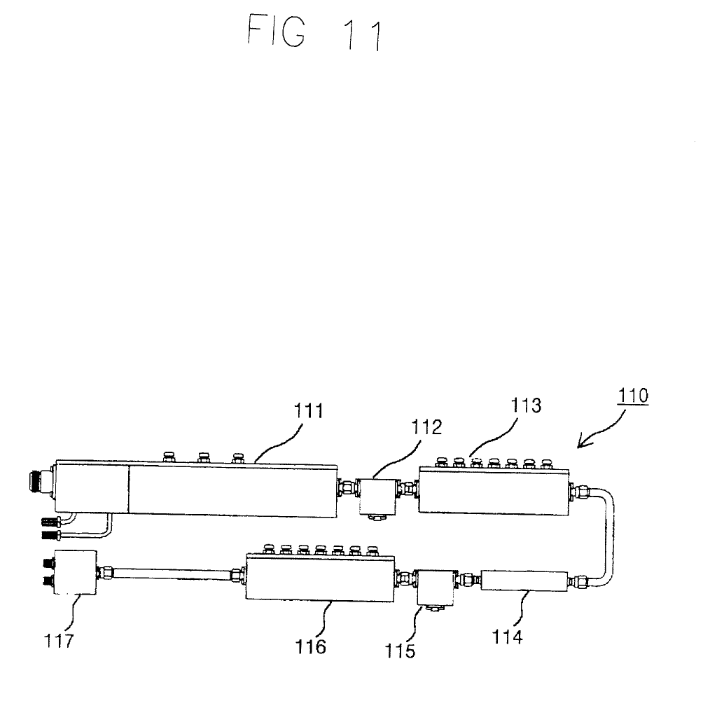

FIG. 11 shows the configuration of a radio system receiver 110 constructed using the aforementioned active filter. Referring to FIG. 11, the receiver 110 of the invention includes an active filter 111, a first isolator 112 that is connected to the back end of the active filter 111 and maintains impedance matching between band pass filters, a first band pass filter 113 that is connected to the back end of the first isolator and passes only a predetermined frequency band, an amplifier 114 connected to the back end of the first band pass filter 113 to amplify signals, a second isolator 115 connected to the back end of the amplifier 114 to maintain impedance matching between the band pass filters, a second band pass filter 116 connected to the back end of the second isolator 115 to pass only the predetermined frequency band, and a power divider 117 connected to the back end of the second band pass filter to divide power.

The receiver of FIG. 11 employs the active filter 111 constructed in a manner that the directional coupler, band pass filter and low noise amplifier are integrated, as shown in FIGS. 7 to 10, and maintains impedance matching between the band pass filters using the two isolators.

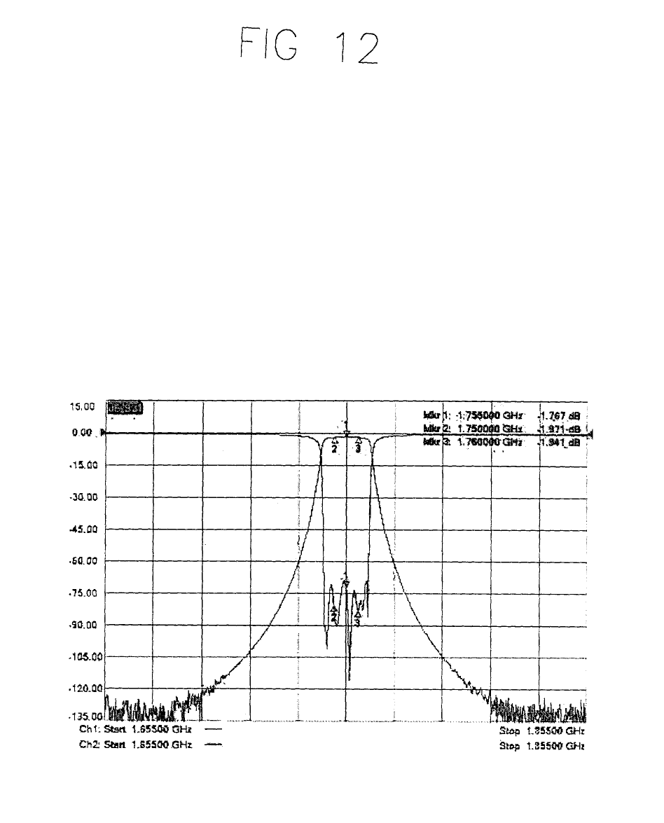

In FIG. 11, the active filter 111 is the same as the active filter described above with reference to FIGS. 7 to 10, and the isolators 112 and 115 are used for impedance matching between elements. The band pass filters attenuate frequency components other than frequency components in a reception bandwidth. The conventional radio system receiver is restricted by the inner space and standard thereof because the stage placed before the low noise amplifier should satisfy attenuation characteristic in bands other than the reception band without employing an additional band pass filter connected to the back end of the low noise amplifier. However, the present invention uses the active filter because insertion loss at the back of the active filter does not affect the noise figure of the system, and improves attenuation characteristic in the entire system by using the band pass filter that is relatively small-sized and has sharp attenuation feature. Furthermore, the present invention can restrain frequency interference of other common carriers while improving the attenuation characteristics of the band pass filters 113 and 116. Accordingly, the RF stage of the base station can realize characteristics of an RF SAW filter, which can be produced only by the IF stage. FIG. 12 shows the output waveforms of the band pass filters 113 and 116.

Meanwhile, as explained above with reference to FIG. 5, the isolator can be integrated with the band pass filters 113 and 116. In general, an active element is broken or replaced on the system more frequently than a passive element because the active element has shorter life span than the passive element. Accordingly, it is preferable to construct the band pass filter and isolator separately from the active filter rather than to construct the isolator inside the active filter that is an active element. In this case, it is possible to integrate the first band pass filter 113 with the first isolator 112 placed before the first band pass filter and to integrate the second band pass filter 116 with the second isolator 115 connected to the front end of the second band pass filter 116. Here, if a drop-in type isolator is attached to the band pass filter, it occupies smaller inner space of the system than a coaxial connector type isolator does, as described above. Accordingly, the entire size of the system becomes smaller.

In FIG. 11, the amplifier 114 has a standard different from that of the low noise amplifier inserted into the active filter 111. The amplifier 114 is designed on the basis of OIP3 standard of the system because the noise figure of the amplifier 114 does not affect the noise figure of the entire system. The standard of the amplifier 114 is as follows.

1. Gain: 30±1 dB

2. Return loss: more than 20 dB

3. Gain flatness: less than ±0.1 dB

4. Noise figure: less than 2.0 dB

5. 1 dB compression point: more than 27 dBm (based on output) (more than 0 dB based on input)

6. OIP3: more than 40 dBm

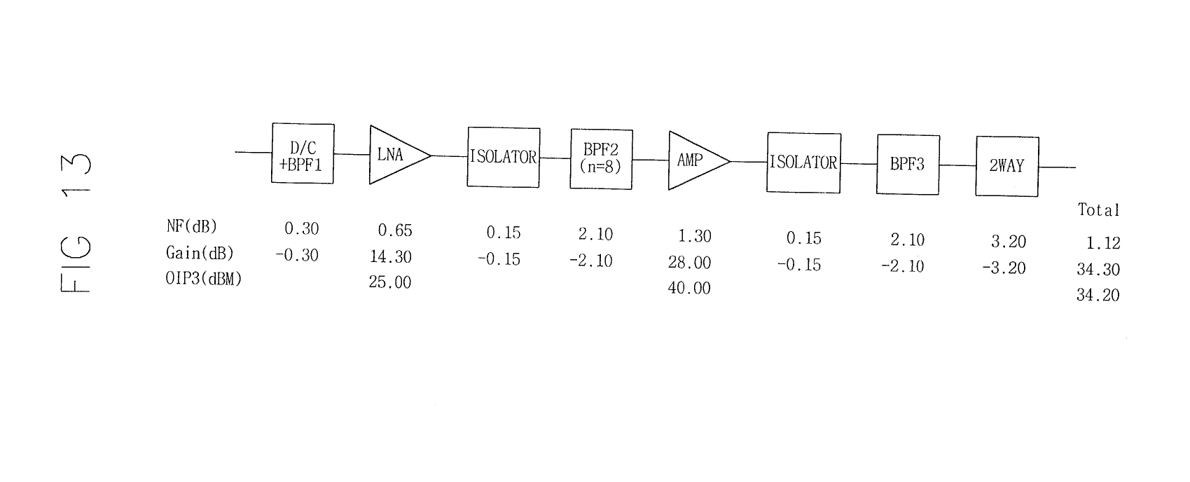

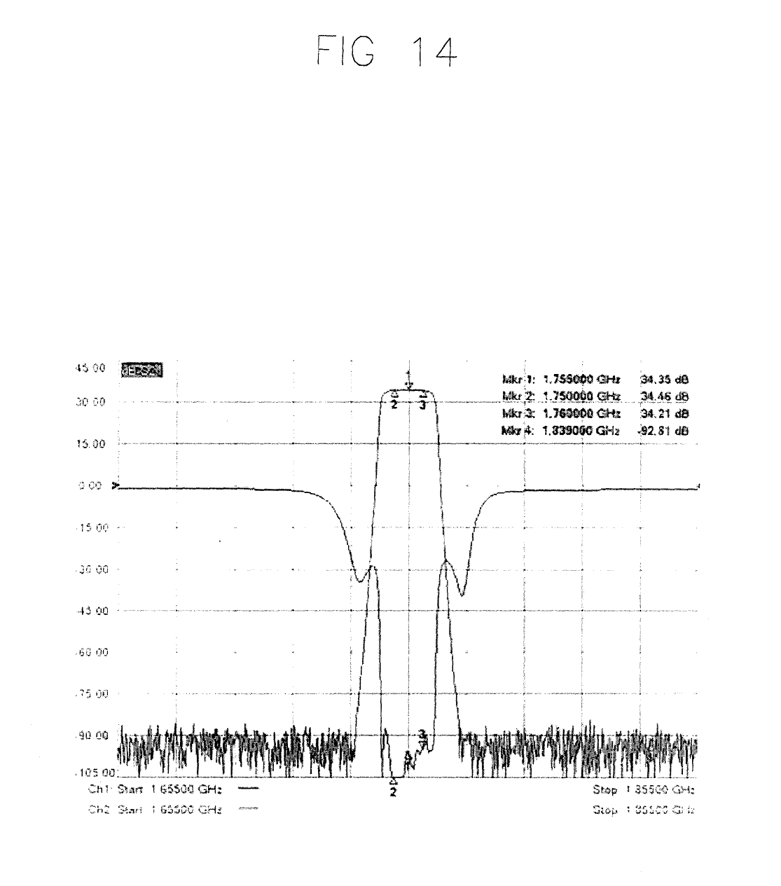

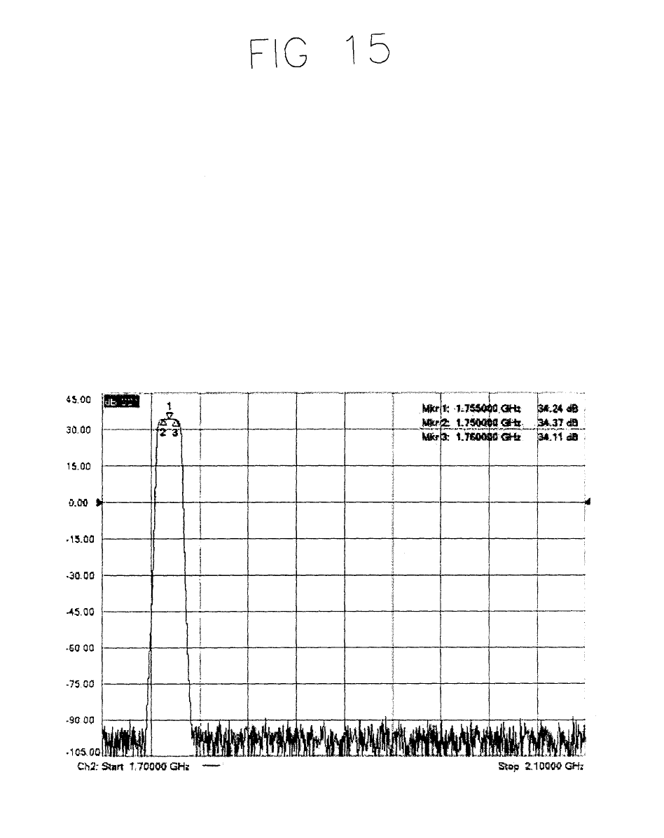

FIG. 13 shows a simulation result with respect to the receiver 110 of FIG. 11. In this case, gain is 34.3 dB and noise figure is 1.12 dB. FIGS. 14 and 15 illustrate the final output waveform of the receiver 110.

In the above-described embodiments, a metal resonator or dielectric resonator is used as the resonator used for the band pass filter. The metal resonator is cheap while the dielectric resonator can remarkably reduce the insertion loss of the band pass filter though it is expensive.

Meantime, to decrease the noise figure of a radio system receiver, TTLNA (Tower TopLNA) structure was used in higher zones such as pylon. An expensive feeder cable was used for transmitting a signal received by TTLNA to the ground, and an additional power transmission line was needed for supplying power to TTLNA. However, the radio system receiver of the invention can reduce the noise figure remarkably, compared with the conventional receiver. Furthermore, since the receiver of the invention can use a general RF cable instead of the expensive feeder cable, it is economical and easy to install and maintain. In addition, it can supply power to TTLNA using the general RF cable without employing an additional power transmission line.

Although specific embodiments including the preferred embodiment have been illustrated and described, it will be obvious to those skilled in the art that various modifications may be made without departing from the spirit and scope of the present invention, which is intended to be limited solely by the appended claims.

According to the present invention, the noise figure of the receiver of an RF or microwave radio system can be reduced to increase the coverage of radio signals. Moreover, the radio system receiver is constructed such that the band pass filter thereof has sharp skirt feature so as to attenuate unnecessary signals, thereby remarkably improving characteristic of the reception stage of a base station. Furthermore, the present invention employs the active filter to increase noise figure characteristic and produces a small-sized radio system receiver.

What is claimed is:

1. A receiver of a radio system of a base station, comprising:
a first band pass filter for passing only a predetermined frequency band of an input signal;
a low noise amplifier for amplifying signals, the low noise amplifier being connected to the back end of the first band pass filter;
a second band pass filter for passing only a predetermined frequency band, the second band pass filter being connected to the back end of the low noise amplifier; and
an amplifier for amplifying signals, the amplifier being connected to the back end of the second band pass filter.

2. The receiver as claimed in claim 1, further comprising an isolator that is connected to the back end of the low noise amplifier and maintains impedance matching between band pass filter.

3. The receiver as claimed in claim 2, wherein the isolator is of drop-in type and included in the second band pass filter to be integrated with it.

4. The receiver as claimed in claim 1, further comprising a third band pass filter that is connected to the back end of the amplifier and passes only a predetermined frequency band.

5. The receiver as claimed in claim 1, further comprising a power divider that is connected to the back end of the amplifier and divides power.

6. The receiver as claimed in claim 1, further comprising a directional coupler that is connected to the front end of the first band pass filter and samples input/output signals to confirm if a signal in a passband operates normally.

7. A receiver of a radio system of a base band, comprising:
an active filter constructed in a manner that a first band pass filter for passing only a predetermined frequency band of an input signal and a low noise amplifier for amplifying a signal inputted from the first band pass filter are integrated with each other;
a second band pass filter for passing only a predetermined frequency band, the second band pass filter being connected to the back end of the active filter; and
an amplifier for amplifying signals, the amplifier being connected to the back end of the second band pass filter.

8. The receiver as claimed in claim 7, further comprising an isolator that is connected to the back end of the active filter and maintains impedance matching between the band pass filters.

9. The receiver as claimed in claim 8, wherein the isolator is of drop-in type and included in the second band pass filter to be integrated with it.

10. The receiver as claimed in claim 8, further comprising a second isolator that is connected to the back end of the amplifier and maintains impedance matching between the band pass filters, and a third band pass filter that is connected to the back end of the second isolator and passes only a predetermined frequency band.

11. The receiver as claimed in claim 10, further comprising a power divider that is connected to the back end of the third band pass filter and divides power.

12. The receiver as claimed in claim 7, wherein the active filter further comprises a directional coupler that is connected to the front end of the first band pass filter and samples input/output signals to confirm if a signal in a passband operates normally.

13. A receiver of a radio system of a base band, comprising:
an active filter constructed in a manner that a first band pass filter for passing only a predetermined frequency band of an input signal and a low noise amplifier for amplifying signals are integrated with each other, the low noise amplifier including a drop-in type isolator for maintaining impedance matching between band pass filters;
a second band pass filter for passing only a predetermined frequency band, the second band pass filter being connected to the back end of the active filter; and
an amplifier for amplifying signals, the amplifier being connected to the back end of the second band pass filter.

14. The receiver as claimed in claim 13, further comprising a second isolator that is connected to the back end of the amplifier and maintains impedance matching between the band pass filters, and a third band pass filter that is connected to the back end of the second isolator and passes only a predetermined frequency band.

15. The receiver as claimed in claim 14, further comprising a power divider that is connected to the back end of the third band pass filter and divides power.

16. The receiver as claimed in claim 14, wherein the active filter further comprises a directional coupler that is connected to the front end of the first band pass filter and samples input/output signals to confirm if a signal in a passband operates normally.

17. The receiver as claimed in claim 14, wherein the resonator of the first band pass filter of the active filter is a metal resonator or dielectric resonator.

18. The receiver as claimed in claim 14, wherein the receiver transmits signals to the outside through an RF cable.
